(19) United States
(12) Patent Application Publication
(10) Pub. No.: US 2026/0328355 A1
(43) Pub. Date: Oct. 22, 2026

(54) LAMP UNIT

(71) Applicant: KOITO MAUFACTURING CO., LTD., Tokyo (JP)

(72) Inventor: Tatsuki ITO, Shizuoka (JP)

(21) Appl. No.: 19/108,846

(22) PCT Filed: Sep. 1, 2023
(86) PCT No.: PCT/JP2023/032061

§ 371 Date: Mar. 5, 2025

(30) Foreign Application Priority Data
Sep. 9, 2022 (JP) 2022-144144

(51) Int. Cl. F21S 41/20; F21S 41/143; F21S 41/265; F21S 41/663; F21W 102/13

(52) U.S. Cl. CPC F21S 41/285; F21S 41/143; F21S 41/265; F21S 41/663; F21W 2102/13

(57) ABSTRACT

Provided is a new lamp reduced in weight. A lamp unit includes a light emitting element having a light emission surface 40b facing the front of a vehicle lamp, and a Fresnel lens 38 having an incident surface 38a facing the light emission surface 40b. The Fresnel lens 38 has a condensing lens portion 38b for condensing light, which is located in front of the light emission surface 40b, and diffusion lens portions 38c, 38d for diffusion, which are provided below the condensing lens portion 38b and on which light L 1, L 2 emitted obliquely downward from the light emission surface 40b is incident. The diffusion lens portions 38c, 38d are configured such that light refracted by diffusion emission surfaces 39c, 39d discontinuous with a condensing emission surface 39b of the condensing lens portion 38b is emitted toward the front of the vehicle lamp.

### TECHNICAL FIELD

The present invention relates to a lamp unit, and for example, relates to a lamp unit used for a vehicle lamp.

### BACKGROUND ART

Conventionally, there has been devised a lamp unit including a light emitting element array in which a plurality of light emitting elements each having an individual irradiation region forming a high-beam light distribution pattern and configured to be individually turned on is mounted in a line on a substrate, a projection lens disposed in front of the light emitting element array, and a reflector disposed below the light emitting element array (see Patent Literature 1).

### CITATION LIST

### Patent Literature

Patent Literature 1: WO 16/013447 A

### SUMMARY OF INVENTION

### Problems to be Solved by Invention

However, the reflector used in the lamp unit as described above is often made of metal from the viewpoint of heat resistance, and tends to be heavy. In addition, in order to reflect more light directed downward from the light emitting element, it is necessary to extend the depth of the reflector, and the thickness of the lamp unit in a vehicle front-rear direction increases.

The present invention has been made in view of such a situation, and an exemplary object thereof is to provide a new lamp unit reduced in weight while achieving desired light distribution.

### Solution to Problems

In order to solve the above-described problems, a lamp unit of a certain aspect of the present invention includes a light emitting element having a light emission surface facing the front of a vehicle lamp, and a Fresnel lens having an incident surface facing the light emission surface. The Fresnel lens has a condensing lens portion for condensing light, which is located in front of the light emission surface, and a diffusion lens portion for diffusion, which is provided below the condensing lens portion and on which light emitted obliquely downward from the light emission surface is incident. The diffusion lens portion is configured such that light refracted by a diffusion emission surface discontinuous with a condensing emission surface of the condensing lens portion is emitted toward the front of the vehicle lamp.

According to this aspect, the light emitted obliquely downward from the light emission surface of the light emitting element can be directed to the front of the vehicle lamp by refraction at the diffusion lens portion. Thus, the thickness of an optical member (Fresnel lens), which is necessary for light distribution control, in the vehicle front-rear direction can be reduced as compared with a case where the light obliquely emitted downward from the light emission surface of the light emitting element is reflected by the reflector to the front of the vehicle lamp. In addition, the Fresnel lens can be formed of a silicone resin lens, and the weight of the lamp unit can be reduced as compared with a case where a metal reflector is used.

A projection lens that projects the light emitted from the Fresnel lens as a light distribution pattern in the front of the vehicle lamp may be further provided. The diffusion lens portion may be configured such that an upper area of the light distribution pattern is irradiated with the emitted light. As a result, it is possible to further expand the irradiation region of the light distribution pattern for irradiating an area above a horizontal line, such as a high-beam light distribution pattern.

Light emitted from the Fresnel lens may be incident on the projection lens without being reflected by other members. Thus, the light emitted from the Fresnel lens reaches the projection lens with a short optical path without being reflected on the way, so that the utilization efficiency of the light of the light emitting element can be improved.

The diffusion lens portion may have a first diffusion lens portion located below the condensing lens portion and having an emission surface in front of the tip end of the condensing lens portion, and a second diffusion lens portion located below the first diffusion lens portion and having an emission surface in front of the first diffusion lens portion. Thus, the light obliquely emitted downward from the light emission surface of the light emitting element can be used for upward diffusion in the irradiation region of the light distribution pattern while reducing the thickness of the entire Fresnel lens.

The second diffusion lens portion may be configured to emit light for irradiating a region of a high-beam light distribution pattern 6 to 8° above the horizontal line.

An arbitrary combination of the above-described components and a converted expression in a manufacturing method, a device such as a lamp or a lighting, a light emitting module, a light source, and the like in the present invention are also effective as aspects of the present invention.

### Effects of Invention

According to the present invention, it is possible to achieve a new lamp unit reduced in weight.

### BRIEF DESCRIPTION OF DRAWINGS

FIG. 1 is a schematic front view of a vehicle headlight according to the present embodiment.

FIG. 2 is a schematic sectional view of the vehicle headlight of FIG. 1 taken along a horizontal plane passing through line A-A in FIG. 1.

FIG. 3(a) is a sectional view of a high-beam lamp unit taken along a vertical plane passing through B-B line in FIG. 2, and FIG. 3(b) is an enlarged view of a portion C in FIG. 3(a).

FIG. 4(a) is a front view of a Fresnel lens according to the present embodiment, and FIG. 4(b) is a perspective view of the Fresnel lens according to the present embodiment.

FIG. 5 is a sectional view showing a main configuration of the high-beam lamp unit according to the present embodiment.

FIG. 6 is a view showing an example of a high-beam light distribution pattern formed by the high-beam lamp unit.

### DESCRIPTION OF EMBODIMENTS

Hereinafter, the present invention will be described based on preferred embodiments with reference to the drawings. The same or equivalent components, members, and processes shown in the drawings are denoted with the same reference numerals, and redundant description will be omitted as appropriate. In addition, the embodiment does not limit the invention but is an example, and all features described in the embodiment and combinations of the features are not necessarily essential to the invention.

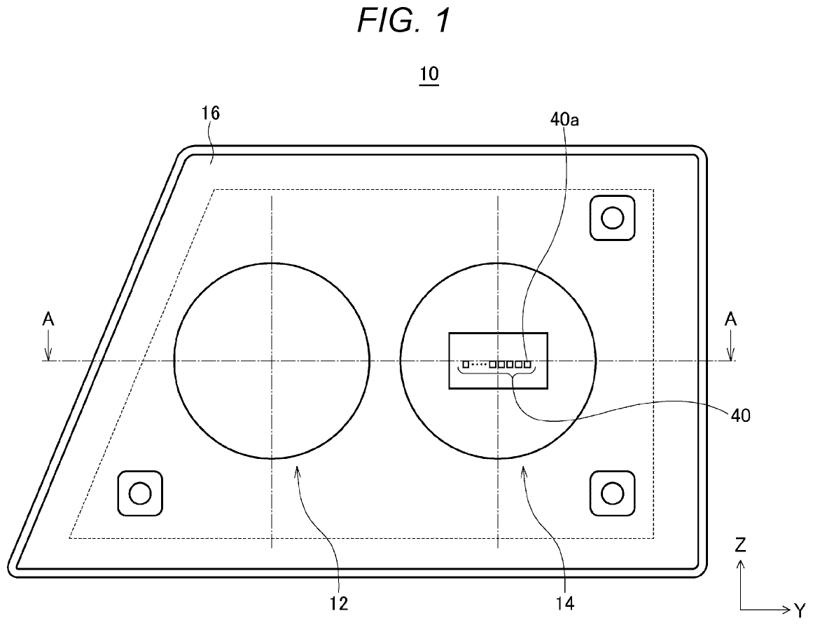

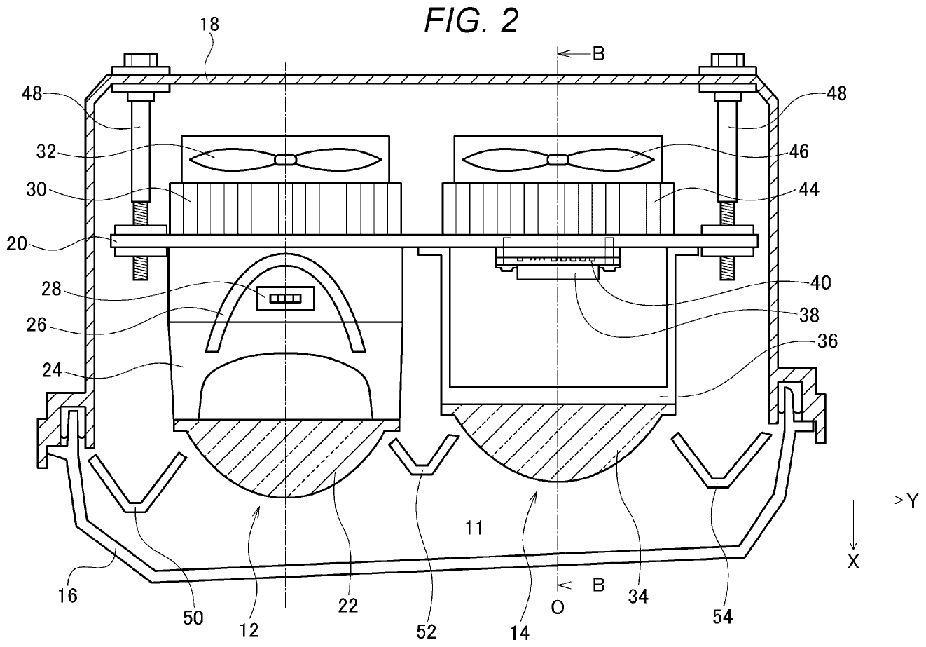

FIG. 1 is a schematic front view showing a vehicle headlight 10 according to the present embodiment. FIG. 2 is a schematic sectional view of the vehicle headlight 10 of FIG. 1 taken along a horizontal plane passing through line A-A in FIG. 1. The vehicle headlight 10 includes a left lamp and a right lamp on both the left and right sides of a front portion of a vehicle body, respectively, but only the right lamp is shown in FIG. 1. Since the left lamp has a configuration similar to that of the right lamp except that the left lamp is symmetrical to the right lamp, illustration thereof is omitted.

The vehicle headlight 10 has a lamp chamber 11 formed of a lamp body 18 (see FIG. 2) having an opening in a vehicle forward direction and a transparent or translucent outer cover 16 covering the opening of the lamp body. In the lamp chamber 11, one low-beam lamp unit 12 and one high-beam lamp unit 14 are arranged.

The low-beam lamp unit 12 and the high-beam lamp unit 14 are fixed on a common support plate 20. The support plate 20 is fixed to the lamp body 18 with a plurality (for example, three) of aiming screws 48. Rotation of the aiming screws 48 enables optical axis adjustment in which the optical axes O of the low-beam lamp unit 12 and the high-beam lamp unit 14 are inclined within a predetermined angular range.

The low-beam lamp unit 12 is a so-called PES lamp unit, and includes, on the front side of the support plate 20, a projection lens 22, a lens holder 24 supporting the projection lens 22, a light emitting element array 28 including a plurality of semiconductor light emitting elements, for example, light emitting diodes (LEDs), and a reflector 26 that reflects light from the light emitting element array 28 toward the projection lens 22. The low-beam lamp unit 12 further includes a heat sink 30 with a heat dissipation fin attached to the back side of the support plate 20 and a cooling fan 32.

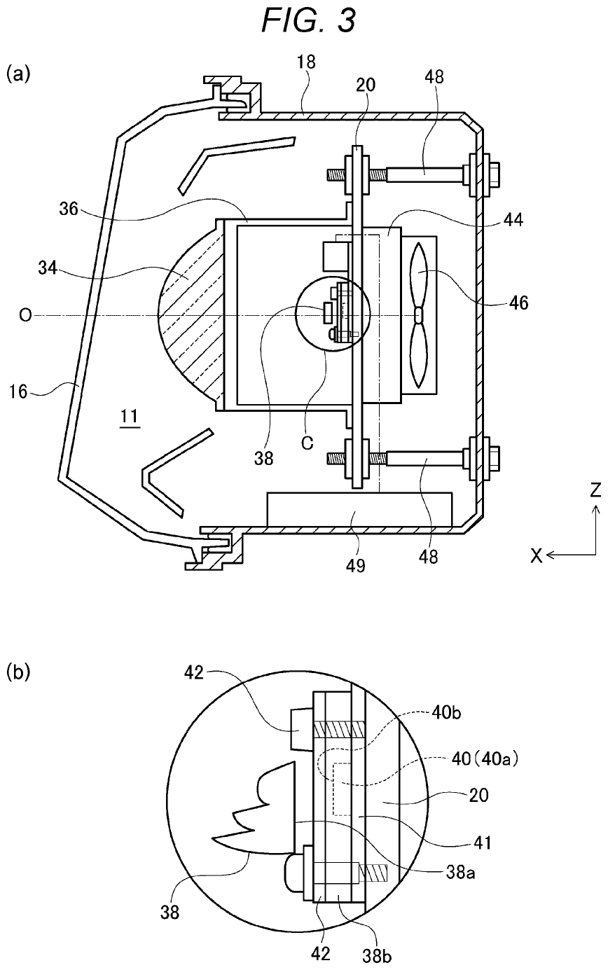

FIG. 3(a) is a sectional view of the high-beam lamp unit 14 taken along a vertical plane passing through B-B line in FIG. 2, and FIG. 3(b) is an enlarged view of a portion C in FIG. 3(a). Hereinafter, the high-beam lamp unit 14 will be described with reference to FIGS. 2 and 3.

The high-beam lamp unit 14 is a lamp unit capable of changing a light distribution pattern according to a traveling status of a vehicle and a surrounding situation. The high-beam lamp unit 14 includes a projection lens 34, a lens holder 36, a Fresnel lens 38, and a light emitting element array 40.

The projection lens 34 includes a plano-convex aspherical lens having a convex front surface and a flat rear surface, and projects a light source image formed on the rear focal surface as an inverted image on a virtual vertical screen in front of the lamp. The projection lens 34 is attached to one opening of the tubular lens holder 36.

The light emitting element array 40 includes one or more (12 in the present embodiment) semiconductor light emitting elements 40a mounted on a substrate 41. The semiconductor light emitting elements 40a have the same shape, and are linearly arranged on the surface of the substrate 41 such that the light emission surfaces thereof face the front of the vehicle headlight 10. Each light emitting element can be individually turned on and off, and is capable of irradiating an individual irradiation region obtained by dividing a high-beam light distribution pattern in the horizontal direction. The individual irradiation region of each light emitting element preferably at least partially overlaps with the individual irradiation region of an adjacent light emitting element.

Each semiconductor light emitting element 40a has a light emitting chip (not shown) and a thin film. The light emitting chip is formed of, for example, a white light emitting diode having a square light emission surface of about 1 mm square. Note that the light emitting chip is not limited thereto, and may be, for example, another element-shaped light source that surface-emits light in a substantially dotted pattern, such as a laser diode. The rear focal point F of the projection lens 34 may be located on the surface of the semiconductor light emitting element 40a, or may be located in front of the semiconductor light emitting element 40a as described later.

The Fresnel lens 38 is disposed in front of the light emitting element array 40. As shown in FIG. 3(b), the Fresnel lens 38 has an incident surface 38a facing a light emission surface 40b of the semiconductor light emitting element 40a.

As shown in FIG. 3(b), a light shielding plate 42 that shields part of light emitted from the light emitting element array 40 is provided in front of the light emitting element array 40.

A control unit 49 for controlling ON and OFF of the light emitting element array 40 is disposed on the bottom surface of the lamp body 18. The control unit 49 detects the position of a preceding vehicle or a pedestrian with a camera (not shown), and controls the light emitting element array 40 so as not to irradiate the individual irradiation region corresponding to such a position, thereby implementing an adaptive driving beam (ADB) that does not give glare to a driver of the preceding vehicle or the pedestrian.

The high-beam lamp unit 14 further includes a heat sink 44 with a heat dissipation fin attached to the back side of the support plate 20 and a cooling fan 46.

In the lamp chamber 11, extensions 50,52, and 54 made of resin are arranged so as to cover a gap formed between the low-beam lamp unit 12, the high-beam lamp unit 14, and the lamp body 18, and hide an internal structure when the vehicle headlight 10 is observed from the front.

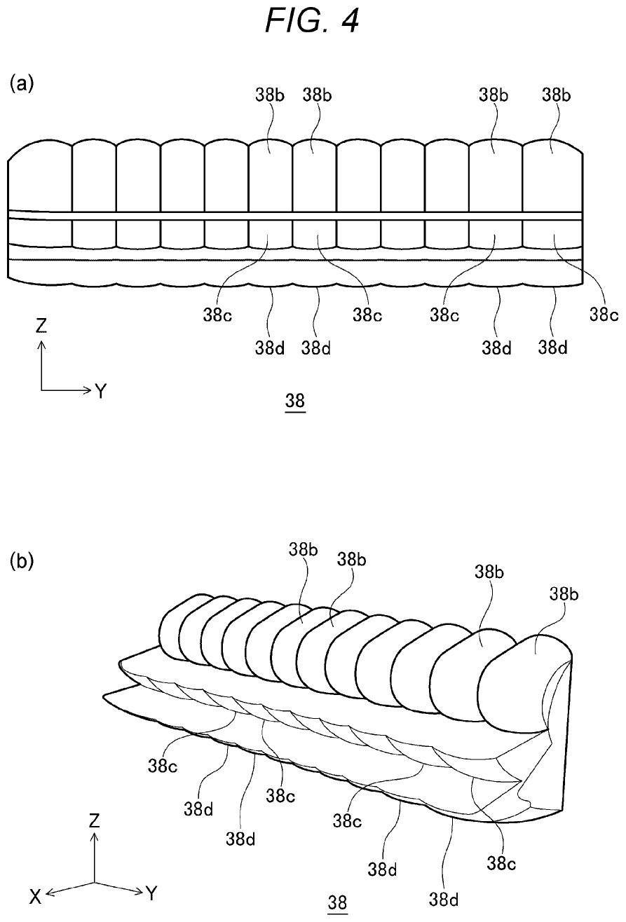

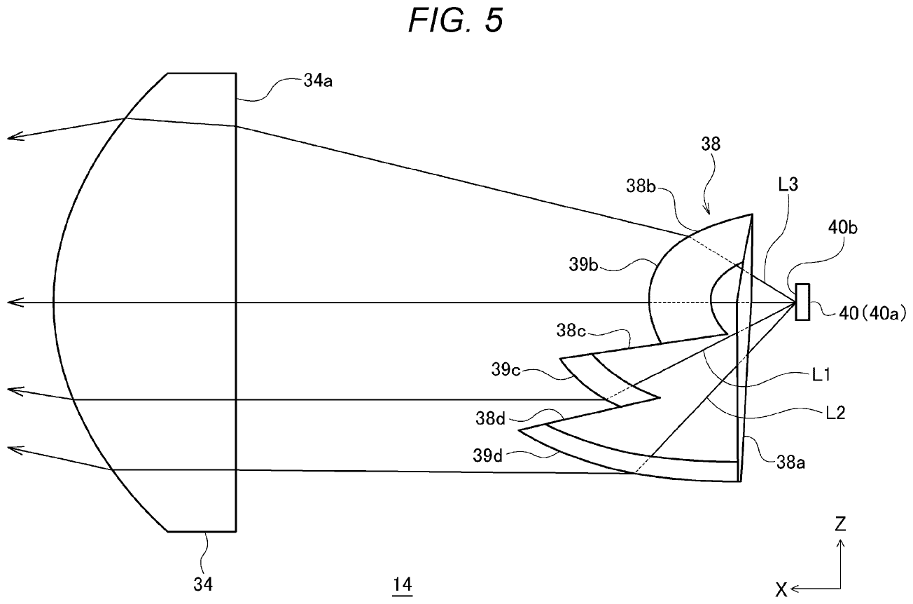

FIG. 4(a) is a front view of the Fresnel lens according to the present embodiment, and FIG. 4(b) is a perspective view of the Fresnel lens according to the present embodiment. FIG. 5 is a sectional view showing a main configuration of the high-beam lamp unit 14 according to the present embodiment.

As shown in FIG. 5, the high-beam lamp unit 14 includes the semiconductor light emitting elements 40a having the light emission surfaces 40b facing the front of the vehicle headlight 10, the Fresnel lens 38 having the incident surface 38a facing the light emission surfaces 40b, and the projection lens 34 that projects light emitted from the Fresnel lens 38 as the light distribution pattern on the front of the vehicle lamp.

The Fresnel lens 38 has a condensing lens portion 38b for condensing light, which is located in front of the light emission surface 40b, a diffusion lens portion 38c for diffusion, which is provided below the condensing lens portion 38b and on which light LI emitted obliquely downward from the light emission surface 40b is incident, and a diffusion lens portion 38d for diffusion, on which light L2 emitted obliquely further downward than the light LI from the light emission surface 40b is incident. The diffusion lens portions 38c, 38d are configured such that light refracted by diffusion emission surfaces 39c, 39d discontinuous with a condensing emission surface 39b of the condensing lens portion 38b is emitted toward the front of the high-beam lamp unit 14.

As shown in FIG. 4(a) and 4(b), the Fresnel lens 38 includes 12 condensing lens portions 38b and 12 pairs of diffusion lens portions 38c, 38d corresponding to 12 semiconductor light emitting elements 40a, respectively.

As a result, the high-beam lamp unit 14 can direct the light L1, L2 obliquely emitted downward from the light emission surface 40b of the semiconductor light emitting element 40a toward the front of the vehicle headlight 10 by refraction at the diffusion lens portions 38c, 38d. Thus, the thickness of the Fresnel lens 38, which is necessary for light distribution control, in a vehicle front-rear direction (X direction) can be reduced as compared with a case where the light L1, L2 obliquely emitted downward from the light emission surface 40b of the semiconductor light emitting element 40a is reflected by a reflector to the front of the vehicle lamp. In addition, the Fresnel lens 38 can be formed of a silicone resin lens, and the weight of the high-beam lamp unit 14 can be reduced as compared with a case where a metal reflector is used.

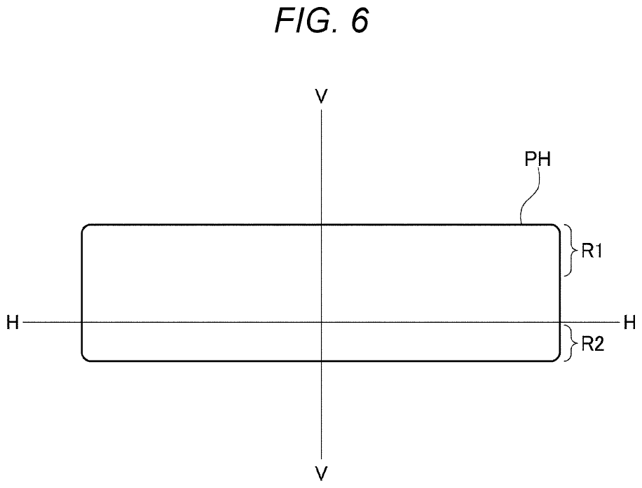

FIG. 6 is a view showing an example of the high-beam light distribution pattern formed by the high-beam lamp unit 14. The diffusion lens portions 38c, 38d are configured such that an upper area R1 of the high-beam light distribution pattern PH is irradiated with the emitted light. As a result, it is possible to further expand the irradiation region of the light distribution pattern for irradiating an area above a horizontal line, such as a high-beam light distribution pattern.

In addition, light L3 obliquely emitted upward from the light emission surface 40b is refracted by the condensing lens portion 38b and further refracted by the projection lens 34 to irradiate a lower area R2 of the high-beam light distribution pattern PH. As a result, it is possible to achieve road surface irradiation for a region below the horizontal line in the light distribution pattern for mainly irradiating the side above the horizontal line, such as the high-beam light distribution pattern.

The projection lens 34 according to the present embodiment is disposed at a position where light emitted from the Fresnel lens 38 is incident without being reflected by other members, in other words, at a position where light emitted from the Fresnel lens 38 is directly incident. Thus, the light emitted from the Fresnel lens 38 reaches the projection lens 34 with a short optical path without being reflected on the way or passing through other members, so that the utilization efficiency of the light of the semiconductor light emitting element 40a can be improved.

The diffusion lens portion according to the present embodiment includes the diffusion lens portion 38c located below the condensing lens portion 38b and having the diffusion emission surface 39c in front of the tip end of the condensing lens portion 38b, and the diffusion lens portion 38d located below the diffusion lens portion 38c and having the diffusion emission surface 39d in front of the diffusion lens portion 38c. Thus, the light obliquely emitted downward from the light emission surface 40b of the semiconductor light emitting element 40a can be used for upward diffusion in the irradiation region of the high-beam light distribution pattern PH while reducing the thickness of the entire Fresnel lens 38.

In particular, the diffusion lens portion 38d is configured to emit light for irradiating a region of the high-beam light distribution pattern PH 6 to 8° above the horizontal line. Alternatively, the diffusion lens portion 38d may be configured to emit light for irradiating a region of the high-beam light distribution pattern PH 6° or more and preferably 8° or more above the horizontal line. In addition, since the diffusion emission surface 39d of the diffusion lens portion 38d is located in front of the diffusion lens portion 38c, a light intensity in the upper area R1 of the high-beam light distribution pattern PH can be further increased, and the utilization rate of the light emitted from the semiconductor light emitting element 40a can be improved.

The high-beam light distribution pattern PH according to the present embodiment, transmitted light (refracted light) transmitted through the Fresnel lens 38 among the light emitted from the light emitting element array 40 is projected in front of the vehicle by the projection lens 34. Thus, unevenness of brightness in the light distribution pattern can be reduced as compared with a light distribution pattern in which direct light and reflected light are mixed as in the case of using the reflector.

The light emission surface 40b of the semiconductor light emitting element 40a according to the present embodiment may have a rectangular shape with one side of about 0.8 to 2.0 mm. In addition, a distance between the light emission surface 40b of the semiconductor light emitting element 40a and the incident surface 38a of the Fresnel lens 38 is about 0.5 to 1.5 mm, which is very close. Thus, the material of the Fresnel lens 38 is preferably a material in consideration of heat resistance and moldability, and may be, for example, silicone or glass. The Fresnel lens 38 has a thickness of about 5 to 10 mm in the Z direction, and the condensing lens portion 38b has a thickness of about 2 to 5 mm in the Z direction. The projection lens 34 has a thickness of about 20 to 30 mm in the Z direction. A distance between the light emission surface 40b of the semiconductor light emitting element 40a and an incident surface 34a of the projection lens 34 is about 20 to 40 mm.

Although the present invention has been described with reference to the above-described embodiment, the present invention is not limited to the above-described embodiment, and embodiments obtained by appropriately combining or replacing the configurations of the embodiment are also included in the present invention. In addition, it is also possible to appropriately recombine the combinations and the order of processing in the embodiments on the basis of the knowledge of those skilled in the art and to add modifications such as various design changes to the embodiments, and the embodiments to which such modifications are added can also be included in the scope of the present invention.

The present international application claims priority based on Japanese Patent Application No. 2022-144144 filed on Sep. 9, 2022, and the entire contents of Japanese Patent Application No. 2022-144144 are incorporated herein by reference.

The description of the specific embodiments of the present invention is presented for the purpose of illustration. The specific embodiments are not intended to be exhaustive or to limit the invention as it is in the form described. It is obvious to those skilled in the art that many modifications and alterations are possible in light of the contents of the description above.

### LIST OF REFERENCE SIGNS

10 Vehicle Headlight
14 High-Beam Lamp Unit
34 Projection Lens
34a Incident Surface
38 Fresnel Lens
38a Incident Surface
38b Condensing Lens Portion
38c Diffusion Lens Portion
380 Diffusion Lens Portion
39b Condensing Emission Surface
39c Diffusion Emission Surface
39d Diffusion Emission Surface
40 Light Emitting Element Array
40a Semiconductor Light Emitting Element
40b Light emission surface
R1 Upper Area
R2 Lower Area
PH High-Beam Light Distribution Pattern

1. A lamp unit comprising:
a light emitting element having a light emission surface facing a front of a vehicle lamp; and
a Fresnel lens having an incident surface facing the light emission surface,
wherein the Fresnel lens has
a condensing lens portion for condensing light, which is located in front of the light emission surface, and
a diffusion lens portion for diffusion, which is provided below the condensing lens portion and on which light obliquely emitted downward from the light emission surface is incident, and
the diffusion lens portion is configured to emit light refracted by a diffusion emission surface discontinuous with a condensing emission surface of the condensing lens portion toward the front of the vehicle lamp.

2. The lamp unit according to claim 1, further comprising: a projection lens that projects light emitted from the Fresnel lens as a light distribution pattern in the front of the vehicle lamp,
wherein the diffusion lens portion is configured to irradiate an upper area of the light distribution pattern with emitted light.

3. The lamp unit according to claim 2, wherein light emitted from the Fresnel lens is incident on the projection lens without being reflected by other members.

4. The lamp unit according to claim 1, wherein
the diffusion lens portion includes
a first diffusion lens portion located below the condensing lens portion and having an emission surface in front of a tip end of the condensing lens portion, and
a second diffusion lens portion located below the first diffusion lens portion and having an emission surface in front of the first diffusion lens portion.

5. The lamp unit according to claim 4, wherein the second diffusion lens portion is configured to emit light for irradiating a region of a high-beam light distribution pattern 6 to 8° above a horizontal line.
